(19) United States
(12) Patent Application Publication
(10) Pub. No.: US 2018/0225391 A1
(43) Pub. Date: Aug. 9, 2018

(54) SYSTEM AND METHOD FOR AUTOMATIC DATA MODELLING

(71) Applicant: Neural Algorithms Ltd., Herzelia (IL)

(72) Inventors: Erez SALI, Savyon (IL); Noam Stern, Ramat Hasharon (IL); Orion Talmi, Kibbutz Ramat HaShofet (IL); Yuval Raviv, Givatayim (IL); Gilad Ivri, Rehovot (IL)

(21) Appl. No.: 15/889,245

(22) Filed: Feb. 6, 2018

Related U.S. Application Data
(60) Provisional application No. 62/454,932, filed on Feb. 6, 2017.

(51) Int. Cl. G06F 17/50; G06F 7/58; G06N 99/00

(52) U.S. Cl. CPC G06F 17/50; G06N 99/005; G06F 7/588

(57) ABSTRACT

A data modeling platform includes a distributed modeling ensemble generator and a progress tracker. The distributed modeling ensemble generator preprocesses and models an input dataset according to a user listing of modeling types, modeling algorithms and preprocessing operations. The generator includes a plurality of model runners, one per modeling type, and a data coordinator. Each model runner operates with a changing plurality of distributed independent modeling services and generates a changing set of points in a hyper-parameter space defining hyper-parameters for the modeling algorithms and preprocessing operations. Each distributed modeling service uses a selected one of the hyper-parameter points and generates a validated score for that point. The data coordinator coordinates the operation of the model runners and provides the hyper-parameter points and their resulting scores to the progress tracker.

### CROSS REFERENCE TO RELATED APPLICATIONS

This application claims priority from U.S. provisional patent application 62/454,932, filed Feb. 6, 2017, which application is incorporated herein by reference.

### FIELD OF THE INVENTION

The present invention relates to data analytics generally and to automatic modeling of data using automatic machine learning algorithms and data processing in particular.

### BACKGROUND OF THE INVENTION

The combination of fast data communication and the availability of low cost storage has generated vast amounts of stored data. The TOT (internet of things) revolution, where many devices have become connected to the internet, has generated lots of data from many devices that are connected to data communication networks. Vast amounts of data were also generated from other sources, such as banking systems, finance systems (such as stock exchange systems), communication systems (such as data gathered from cellular phones), e-commerce systems, transportation (such as GPS systems mounted on vehicles).

Companies have begun to analyze this data (known as “Big Data”), to extract patterns, learn its trends, and to classify and cluster items into similarity groups. For example, there are systems that use historical data to predict demand for an item. Other systems detect anomalies in financial transactions or in operation of a production environment. Still other systems study customer patterns of activities to identify customers who are not satisfied and may leave, or to predict what products a customer might buy based on his personal features, purchase history, etc.

There is a whole range of algorithms, known as machine learning algorithms, that are designed to automatically learn from the data given to them. Machine learning algorithms include regression, classification, recommendation, time series prediction, clustering, collaborative filtering, anomaly detection, etc. In most cases, the user first manually builds a model of the data, tests it and repeatedly refines it. This is a typically a time-consuming process.

Many software packages implement machine learning algorithms, such as the SKlearn package, available at http://scikit-learn.org/, the Tensorflow software package, available at https://www.tensorflow.org/, or the Keras software package, available at https://keras.io/, or Matlab, available at https://www.mathworks.com/products/matlab.html.

Moreover, U.S. Pat. No. 9,489,630 to Achin et al., entitled “System and Techniques for Predictive Data Analytics” discusses a platform for handling machine learning algorithms.

### SUMMARY OF THE PRESENT INVENTION

There is therefore provided, in accordance with a preferred embodiment of the present invention, a data modeling platform. The platform includes a modeling ensemble generator and a progress tracker. The modeling ensemble generator preprocesses and models an input dataset according to a user listing of modeling types, modeling algorithms and preprocessing operations. Progress tracker displays a progress of the modeling ensemble generator. The generator includes a plurality of model runners one per modeling type, and a data coordinator. Each model runner operates with a changing plurality of independent modeling services and generates a changing set of points in a hyper-parameter space defining hyper-parameters for the listed modeling algorithms and preprocessing operations. Each modeling service models the data using a selected one of the hyper-parameter points and generates a validated score for the selected hyper-parameter point. The data coordinator coordinates the operation of the model runners and provides the hyper-parameter points and their resulting scores generated by the independent modeling services to the progress tracker.

There is also provided, in accordance with a preferred embodiment of the present invention, a data modeling platform which includes a distributed modeling ensemble generator and a progress tracker. The distributed modeling ensemble generator includes a plurality of model runners, one per modeling type, and a data coordinator. Each model runner operates with a changing plurality of distributed independent modeling services and each model runner generates a changing set of points in the hyper-parameter space. Each distributed modeling service models the data using a selected one of the hyper-parameter points and generates a validated score for the selected hyper-parameter point, the plurality of modeling services changing as a function of a convergence of a final model to the input dataset. The data coordinator coordinates the operation of the model runners and provides the hyper-parameter points and their resulting scores generated by the independent distributed modeling services to the progress tracker.

Moreover, in accordance with a preferred embodiment of the present invention, each model runner includes a point spawner, a success determiner and a blender generator. The point spawner generates the hyperparameter points across the hyper-parameter space and provides the points to the progress tracker. The success determiner receives the scores from the modeling services and selects those of the validated scores indicating a quality match to the data. The blender generator blends together a group of the selected scores to generate a blended model providing better results than each validated score by itself and validates the blended model on a portion of the input data not utilized by the modeling services.

Further, in accordance with a preferred embodiment of the present invention, the point spawner includes at least one of a random number generator to select points at random, an optimizer to select points in order to find scores providing better results than previously generated by the modeling services, and a meta learning unit to select points based on score results produced with a similar dataset to the input dataset.

Still further, in accordance with a preferred embodiment of the present invention, the optimizer includes a searcher to search for new hyper-parameter points by adjusting the score of a point according to its contribution to a current blended model.

Moreover, in accordance with a preferred embodiment of the present invention, the progress tracker includes a grapher and a user interface. The grapher graphs the points in a branched node graph representing the progress of the model runners, where branches in the graph represent one of: time, hyper-parameters or algorithm type. The user interface provides the hyper-parameters and the score associated with a user-selected node.

Further, in accordance with a preferred embodiment of the present invention, the modeling types includes classification, recommendation, anomaly detection, regression, and time-series prediction.

Still further, in accordance with a preferred embodiment of the present invention, each modeling service includes a computing device having computational abilities and resources, a point selector, a pre-processing model generator and scorer and a results analyzer. The point selector selects a hyper-parameter point to model based on the computational abilities and resources compared to those required for a model indicated by the selected hyper-parameter point. The pre-processing model generator and scorer runs the model indicated by the hyper-parameter point on a first portion of the input data to determine algorithm parameters of the model and generates an initial score for the selected hyper-parameter point. The results analyzer generates the validated score by running the model on a second portion of the input data.

Moreover, in accordance with a preferred embodiment of the present invention, the computational abilities and resources comprise at least one of: amount of RAM, CPU type, number of processing cores, type of GPU (graphics processing unit), installed software libraries, available memory, and installed operating system.

Further, in accordance with a preferred embodiment of the present invention, the computing device is part of a cloud-based computing service.

Still further, in accordance with a preferred embodiment of the present invention, the data modeling platform also includes a database to store at least final blended models generated by the modeling ensemble generator and an exporter to export the final blended models.

Moreover, in accordance with a preferred embodiment of the present invention, each modeling service includes a poor performance definer to define at least one of: a maximum level of complexity of the model, a maximum amount of memory used to implement the model, a maximum number of algorithm parameters for the model.

There is also provided, in accordance with a preferred embodiment of the present invention, a method for a data modeling platform. The method includes preprocessing and modeling an input dataset according to a user listing of modeling types, modeling algorithms and preprocessing operations, and displaying a progress of the preprocessing and modeling. The preprocessing and modeling includes per modeling type, running a plurality of models on a changing plurality of independent modeling services, and coordinating the running to provide the hyper-parameter points and their resulting scores generated by the independent modeling services for the displaying. Each running includes generating a changing set of points in a hyper-parameter space defining hyper-parameters for the listed modeling algorithms and preprocessing operations, and each modeling service modeling the data using a selected one of the hyper-parameter points and generating a validated score for the selected hyper-parameter point.

There is also provided, in accordance with a preferred embodiment of the present invention, a method for a data modeling platform. The method includes distributed preprocessing and modeling of an input dataset according to a user listing of modeling types, modeling algorithms and preprocessing operations; and displaying a progress of the distributed preprocessing and modeling. The distributed preprocessing and modeling includes per modeling type, running a plurality of models on a changing plurality of distributed independent modeling services, and coordinating the running to provide the hyper-parameter points and their resulting scores generated by the independent distributed modeling services for the displaying. Each running includes generating a changing set of points in a hyper-parameter space defining hyper-parameters for the listed modeling algorithms and preprocessing operations, and each distributed modeling service modeling the data using a selected one of the hyper-parameter points and generating a validated score for the selected hyper-parameter point, the plurality of modeling services changing as a function of a convergence of a final model to the input dataset.

Moreover, in accordance with a preferred embodiment of the present invention, each running includes at least one of: generating the hyperparameter points across the hyper-parameter space, providing the points for the displaying, selecting those of the validated scores indicating a quality match to the data, blending together a group of the selected scores to generate a blended model providing better results than each validated score by itself; and validating the blended model on a portion of the input data not utilized by the modeling services.

Further, in accordance with a preferred embodiment of the present invention, the generating includes selecting points at random, selecting points in order to find scores providing better results than previously generated by the modeling services, and selecting points based on score results produced with a similar dataset to the input dataset.

Still further, in accordance with a preferred embodiment of the present invention, the second selecting includes searching for new hyper-parameter points by adjusting the score of a point according to its contribution to a current blended model.

Moreover, in accordance with a preferred embodiment of the present invention, the displaying includes graphing the points in a branched node graph representing the progress of the preprocessing and modeling, where branches in the graph represent one of: time, hyper-parameters or algorithm type, and providing the hyper-parameters and the score associated with a user-selected node.

Further, in accordance with a preferred embodiment of the present invention, each modeling service includes selecting a hyper-parameter point to model based on the computational abilities and resources of a computing device running the modeling service compared to those required for a model indicated by the selected hyper-parameter point, running the model indicated by the hyper-parameter point on a first portion of the input data to determine algorithm parameters of the model, generating an initial score for the selected hyper-parameter point, and generating the validated score by running the model on a second portion of the input data.

Still further, in accordance with a preferred embodiment of the present invention, the method also includes storing at least final blended models generated by the modeling ensemble generator and exporting the final blended models.

Finally, in accordance with a preferred embodiment of the present invention, each modeling service includes measuring performance as a function of at least one of: a maximum level of complexity of the model, a maximum amount of memory used to implement the model, a maximum number of algorithm parameters for the model.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic diagram of a system that automatically creates a generally optimal data model of known machine learning algorithms with minimal activity by the user, constructed and operative in accordance with a preferred embodiment of the present invention;

FIG. 2A is a schematic illustration of exemplary three-dimensional hyper-parameter space;

FIG. 2B is a user interface selection of a few of the hyper-parameter model types that a user may select from;

FIG. 2C is a user interface selection of a few of the score or target metrics that a user may select from;

FIG. 3 is a schematic illustration of model runners and modeling services, forming part of the system of FIG. 1;

FIG. 4A is an illustration of a progress graph, useful in understanding the system of FIG. 1;

FIG. 4B is a graphical illustration of a score graph 63; and

FIG. 5 is a flowchart illustration of a workflow for the system of FIG. 1.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Applicant has realized that to use the prior art algorithms, one needs to be familiar with the variety of algorithm types and their internal parameters, know how to select an optimal model type, and know how to tune the model so that it fits the available data and know how to pre-process the data before it is used by the model. Furthermore, the process of trying various models with various model “hyper-parameters” may take a long time, require a lot of computation power and may require many tries until an optimal model is selected.

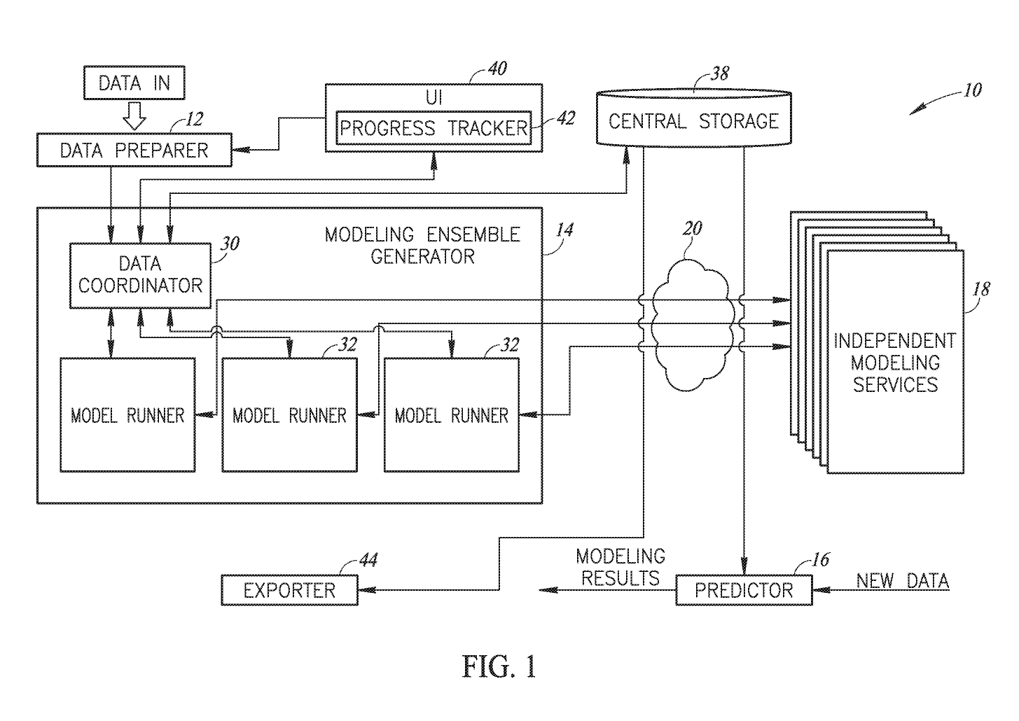

Reference is now made to FIG. 1, which illustrates a system 10 that automatically creates a generally optimal data model of known machine learning algorithms with minimal activity by the user. System 10 comprises a data preparer 12, a modeling ensemble generator 14, and a predictor 16. Modeling ensemble generator 14 may operate with an expanding and shrinking set of independent modeling services 18, externally accessible via a network 20, such as the internet or other network. Modeling ensemble generator 14 may search through a hyper-parameter space (HPS), described in more detail hereinbelow, of preprocessing and operational parameters. Each point in the hyper-parameter space may define a separate model of the data and modeling ensemble generator 14 may continually choose points in the hyper-parameter space, spawning associated new models to be computed by one of the independent modeling services 18. As a modeling service 18 finishes its computation and determines its score, it becomes available for computing a new model.

At various points during the modeling process, modeling ensemble generator 14 may blend the more successful models together, to generate a candidate blended model which may match the data to be modeled better than a single model may match by itself.

In accordance with a preferred embodiment of the present invention, modeling services 18 are implemented as different instances on cloud-based computational resources, such as the Amazon Web Services or Microsoft Azure Cloud Computing Platform and therefore, the number of instances that modeling ensemble generator 14 may activate at any one time is a function of the modeling process. Thus, modeling ensemble generator 14 may expand and shrink computational resources as models are spawned or finish being computed. This may provide modeling ensemble generator 14 with the ability to easily scale as a function of the kind of modeling operation requested by the user.

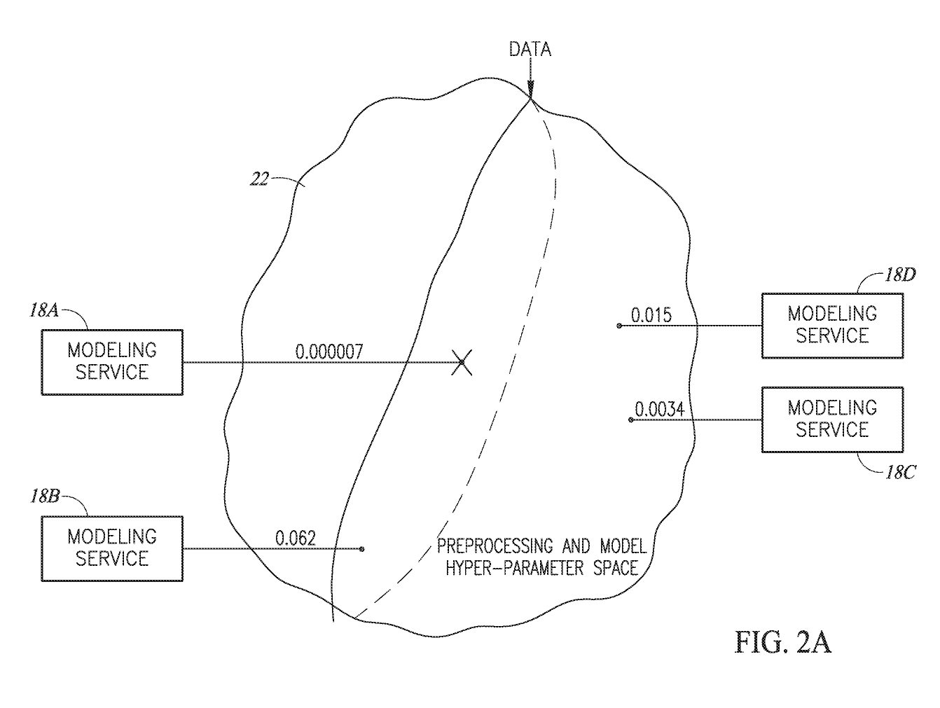

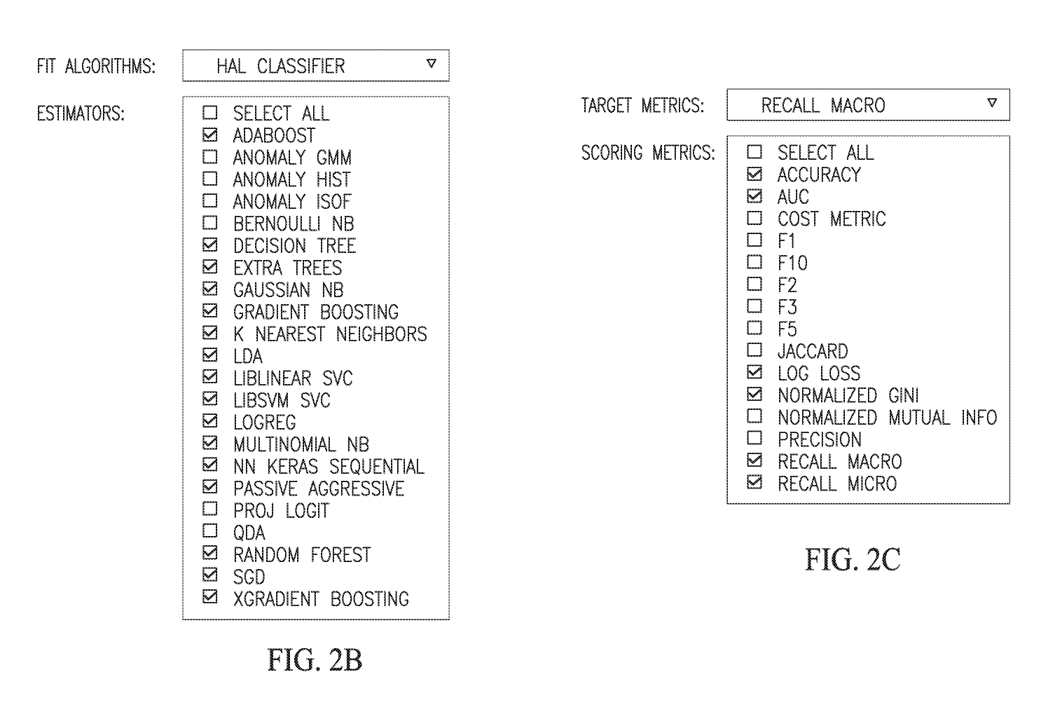

Reference is now made to FIG. 2A, which illustrates an exemplary three-dimensional hyper-parameter space 22, it being understood that, in general, the hyper-parameter space may be of many more dimensions. Reference is also made to FIG. 2B, which list a few of the hyper-parameter model types that a user may select.

In accordance with a preferred embodiment of the present invention, hyper-parameters may be the parameters of the type of the model as well as preprocessing parameters. System 10 may provide many different general types of modeling (such as regression, classification, time series prediction, recommendation (a.k.a collaborative filtering) and anomaly detection), each of which may have different types of algorithms. These types of modeling algorithms are discussed in the following books and online documentation, all of which are incorporated herein by reference:
Foundations of Machine Learning, by Mehryar Mohri, Afshin Rostamizadeh and Ameet Talwalkar, ISBN:9780262018258;
SKLearn site, http://scikit-learn.org
Deep Learning, by Ian Goodfellow, Yoshua Bengio and Aaron Courville, MIT press, ISBN: 9780262035613; and
An Introductory Study on Time Series Modeling and Forecasting, by Ratnadip Adhikari, R. K. Agrawal, LAP Lambert Academic Publishing, Germany, 2013.

For example, the possible types of regression algorithms might be Adaboost, Automatic Relevance Determination Regression (ARD) Regression, Decision tree, Neural network, Extra trees, Gaussian process, gradient boosting, K nearest neighbors, Least angle regression (LARS), Linear regression, Support vector regression, Random forest, Ridge regression, Stochastic gradient descent regression, and Xgradient boosting. The possible types of modeling algorithms for classification might be Adaboost, Gaussian mixture model, Bayesian histograms, Decision tree, Extra trees, Gaussian naïve bayes, Gradient boosting, K nearest neighbors, Linear discriminant analysis, Linear support vector machine, Logistic regression, Multinomial naïve bayes, Neural networks, Passive aggressive, Quadratic discriminant analysis (QDA), Random forest, Stochastic gradient descent, and Xgradient boosting.

The possible types of collaborative filtering algorithms may be Matrix factorization based (discussed in the article “Matrix Factorization Techniques for Recommender Systems” by Yehuda Koren, Robert Bell, Chris Volinsky, Computer, Volume: 42, Issue: 8, Aug. 2009, incorporated herein by reference) or item based models (discussed in the article by Sarwar B., Karypis G., Konstan J., Riedl J., “Item-based Collaborative Filtering Recommendation Algorithms,” Published in the Proceedings of the 10th International Conference on World Wide Web, Hong Kong, ACM 1581133480/01/0005, ©ACM, May 15, 2001, incorporated herein by reference). The possible types of anomaly detection algorithms may be Density-based anomaly detection, such as K-nearest neighbors, local outlier factor (LOF) or Clustering-based anomaly detection, such as K-means or Histogram based. The possible types of time series prediction algorithms may be ARIMA, SARIMA, and Recurrent neural networks.

For example, the possible types of regression algorithms might be Adaboost, Automatic Relevance Determination Regression (ARD) Regression, Decision Tree, Neural network, Extra Trees, Gaussian Process, Gradient Boosting, K Nearest Neighbors, Least Angle Regression (LARS), linear regression, Support Vector Regression, Random Forest, Ridge Regression, Stochastic gradient descent regression, and Xgradient Boosting. The possible types of modeling algorithms for classification might be Adaboost, Gaussian mixture model, Bayesian Histograms, Decision Tree, Extra Trees, Gaussian naïve bayes, Gradient Boosting, K Nearest Neighbors, Linear discriminant analysis, linear support vector machine, Logistic regression, Multinomial naïve bayes, Neural networks, Passive Aggressive, Quadratic Discriminant Analysis (QDA), Random Forest, Stochastic gradient descent, and Xgradient Boosting. The possible types of collaborative filtering algorithms may be Matrix factorization based (Koren, August 2009.) or item-based models (Sarwar B., May 15, 2001). The possible types of anomaly detection algorithms may be Density-Based Anomaly Detection, such as k-nearest neighbors, local outlier factor (LOF) or Clustering-Based Anomaly Detection, such as k-means or histogram based. The possible types of time series prediction algorithms may be ARIMA, SARIMA, and recurrent neural networks.

In accordance with a preferred embodiment of the present invention, hyper-parameters also include types of preprocessing operations. For example, the pre-processing hyper-parameters may include an indication to perform various types of pre-processing operations, such as thresholding the data, scaling the data or transforming the data, such as with a log or sine operation. For dataset which list features, such as those where classification is required, the preprocessing operations might be feature aggregation, feature selection or feature embedding, the latter of which requires a kernel to be applied to the dataset. For example, the kernel for feature embedding may be selected from RBF sampler, random trees, Truncated SVD/PCA/ICA, Feature selection, or dimensionality reduction, may be either by selecting mutual information or by selecting the more important features. Other types of data pre-processing hyper-parameters may involve type inference (i.e. classifying the data into Numerical/Categorical/Date feature types), imputing new data by adding a new value, a most common value, a median or an average, or cleaning the data, for example by removing constant features or replacing specific values. The data can be rescaled or normalized, such as by requiring the L1 or L2 metrics of each vector-to be 1, standardized to have a mean of 0 and a standard deviation of 1 or normalized by an extremum value (minimum or maximum). Furthermore, the data may be changed by one hot encoding. One hot encoding is explained in the SKLearn documentation at http://scikit-learn.org/stable/modules/generated/sklearn.preprocessing.OneHotEncoder.html, incorporated herein by reference, or by selecting principal components (PCA transform), as explained in the SKlearn documentation at http://scikit-learn.org/stable/modules/generated/sklearn.decomposition.PCA.html, incorporated herein by reference.

The pre-processing may also involve adding additional features, such as replacing a feature vector with its cluster mean, adding a result of a linear or higher order regressor as an additional feature to the input data (known as “stacking”), embedding data and data of time features. For example, time features may be time of day, if the date is a weekend or happens at night, etc.

As can be seen, there may be a large number of hyper-parameters, many of which may have multiple values. To start the model calculation, modeling ensemble generator 14 may select a few points within hyper-parameter space 22 (FIG. 2A shows four of them) and may provide them to modeling services 18. Each modeling service 18 may run its model and may generate a score, indicating how well the data to be modeled matched the model. FIG. 2A shows exemplary score values for each of the four models, where a model created by modeling service 18A has a score of 0.000007, a model created by modeling service 18B has a score of 0.062, a model created by modeling service 18C has a score of 0.0034 and a model created by modeling service 18D has a score of 0.15. Clearly the model created by modeling service 18A has a model with low score which doesn't match the data to be modeled. Such a model will not be included in the ensemble, or blend, of models which model runner 32 may produce, as described in more detail hereinbelow. hyper-parameter

Referring back to FIG. 1, data preparer 12 may receive raw data to be modeled from the user and may check that the data is in a correct format to be handled. Data preparer 12 may also request, via a user interface 40, that the user define the general type of modeling to perform, and at least some of the algorithms and preprocessing operations to be performed. In addition, user interface 40 may require that the user define an optimization target, such as minimizing a function of the data or achieving a successful classification, along with the scoring metrics used to calculate that optimization target. FIG. 2C, to which reference is now briefly made, lists possible scoring metrics, such as median, R1, R squared, F-measure and ROC, as described in the article, incorporated herein by reference, by Powers, David M W. “Evaluation: From Precision, Recall and F-Measure to ROC, Informedness, Markedness & Correlation”, Journal of Machine Learning Technologies, 2 (1): 37-63, 2001 and RMSE (root-mean-square error).

User interface 40 may also allow the user to review and edit the raw data, as necessary, and may enable the user to define a “schema” defining how to parse the columns of data. Schema define the following:

the type of each column (e.g. numerical, time, ID, categorical);

the target column in the data;

feature values that, for whatever reason, should not be used; and

features with BLOCK_ID values. Features with the BLOCK-ID value cannot be in both a training and a validation dataset, described in more detail hereinbelow.

Data preparer 12 may provide the raw data and the information gathered by user interface 40 to modeling ensemble generator 14, which may comprise a data coordinator 30 and multiple model runners 32. Modeling ensemble generator 14 may operate with a central storage unit 38, with a model exporter 44 and with user interface 40, which may comprise a progress tracker 42.

Central storage unit 38 may store the pre-processing and various machine learning algorithm definitions, as well as the list of hyper-parameters available to be used. Central storage unit 38 may also store information about each task, such as the models generated, scores, the resultant ensemble information and any generated predictions. It may also store configuration parameters, user account information, etc.

Data coordinator 30 may receive the raw input data from the user and may also receive user instructions as to the general type of model (e.g. classification vs regression) to be created. Data coordinator 30 may then retrieve algorithms to be used from central storage unit 38. With the initial hyper-parameters defined, data coordinator 30 may then allocate the retrieved algorithms and the initial hyper-parameters to multiple model runners 32.

Data coordinator 30 may also select which portions of the input data to use during the modeling operation. As is known in the art, a first portion of the data may be used for the modeling or training process and a second portion may be used to “validate” the data and to produce the score. This second portion may sometimes be indicated by the Blocking ID. In accordance with a preferred embodiment of the present invention, a third portion may be used for final testing of the blended model. Two different methods of dividing the data are typically used, “hold out data”, where X % of the data is held back for validation and Y % is held back for final testing, and “cross validation data”, where changing small percentages of the data are held back for validation and final testing. For anomaly detection and classification tasks, the selection of the subset may be via stratified sampling, which ensures that a sufficient number of samples from each class exist both in the training and in the validation portions of the data.

Model runners 32 may run the modeling process. There may be one model runner 32 per general type of model. For example, one model runner 32 may run the regression analysis modeling, while another may run the classification type of modeling. As described in more detail hereinbelow, each model runner 32 may generate a list of points in hyper-parameter space to be run by independent modeling services 18. Each modeling service 18 may ‘grab’ a point in this list, as described in detail hereinbelow, and may generate a model for the data with the grabbed point. Each model runner 32 may receive the score information from each modeling service 18, may analyze the score and may provide it to data coordinator 30, to provide the hyper-parameter point and resultant scores to progress tracker 42.

In addition, each model runner 32 may generate an optimal “ensemble model” from the current “best” scores, where the definition of “best” may be any suitable definition, such as the top N models, or those above a certain threshold value. Each model runner 32 may provide its final, ensemble model to data coordinator 30 which, in turn, may store the final model in central storage 38.

Data predictor 16 may receive the final model stored in central storage 38 and may generate predictions, classifications, anomaly detections and/or recommendations on new input data using the final blended model.

Exporter 44 may receive the final model stored in central storage 38 and may export the final model in a form of a compiled component or source code or an executable so that the user may use it on his own systems without having to access system 10. The exported model may be an approximate model with a smaller size or which may have a smaller computational complexity when using it for prediction.

User interface 40 also comprises progress tracker 42, which may show the user the progress of the modeling operation. In one embodiment, progress tracker 42 may provide a graph, described in more detail hereinbelow, of the models currently being run and their relationship with other models.

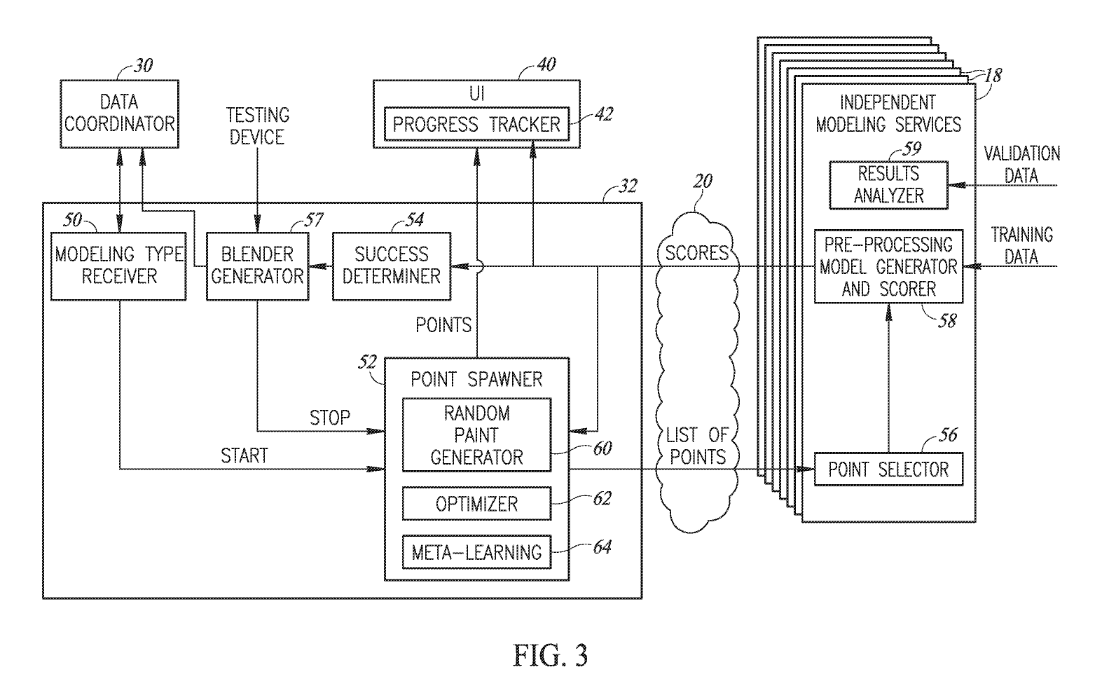

Reference is now made to FIG. 3, which details the elements of model runners 32 and modeling services 18. Each model runner 32 comprises a modeling type receiver 50, a point spawner 52, a success determiner 54, and a blender generator 57. Each modeling service 18 comprises a point selector 56, a preprocessing model generator and scorer 58 and a results analyzer 59.

Modeling type receiver 50 may receive the selected type of modeling (regression, classification, recommendation, anomaly detection, etc.) and may generate an initial set of hyper-parameters (usually a random set or one learned in previous modeling runs of a similar type of data). Modeling type receiver 50 may provide these points to point spawner 52 which may, in turn, provide access to this initial set of hyper-parameters to modeling services 18 to run the model(s) for this initial set of hyper-parameters and to provide a score for the initial models.

Success determiner 54 may review the score results received from each modeling service 18 and may determine which models have reached a sufficiently good score so that they can be used in a final ensemble. In addition, determiner 54 may indicate to point spawner 52 to generate a new list of points to check in hyper-parameter space.

Blender generator 57 may receive the “best” scores from success determiner 54 and may generate an optimal “ensemble model” from the current “best” scores, where the definition of “best” may be any suitable definition, such as the top N models, or those above a certain threshold value. Blender generator 57 may also test the current blended model on the final testing data and may send the testing results to be presented to the user in the UI. It will be appreciated that the blended model may change over time, as the top models improve with the calculation. Blender generator 57 may determine when the final model has been achieved and may provide it to data coordinator 30 for storage in central storage unit 38.

Blender generator 57 may perform the blending in any suitable way, such as those described in the following articles, incorporated herein by reference: Caruana, A. Niculescu-Mizil, G. Crew, and A. Ksikes. “Ensemble Selection from Libraries of Models.” In Proc. of ICML'04, page 18, 2004 and Caruana, A. Munson, and A. Niculescu-Mizil. “Getting the Most out of Ensemble Selection.” In Proc. of ICDM'06, pages 828-833, 2006.

Blender generator 57 may determine that the final blended model has been achieved based on any one of the following criteria:
a) Upon reviewing the results of the current blended model on the final testing data, a desired performance threshold has been achieved, such as the results have not changed by more than M % over the last few iterations or the blended model matches the final testing data to within a predefined threshold;
b) The user stopped the search;
c) The blended model hasn't changed for a predetermined period of time;
d) Time runs out; or
e) A maximal number of models has been reached.

Blender generator 57 may then indicate to data coordinator 30 that the final blended model has been achieved and may indicate to point spawner 52 to stop spawning new points.

Point spawner 52 may continually “spawn” a new list of points, each a set of hyper-parameters, in any suitable way. For example, point spawner 52 may generate hyper-parameters randomly, typically using a random point generator 60. For example, random point generator 60 may assign numbers to all model types and to all hyper-parameters, and may, for each hyper-parameter, map any values which may be forbidden. Random point generator 60 may also map all dependencies between the hyper-parameters (e.g. hyper-parameter A cannot have value B if hyper-parameter C has value D). With this, random point generator 60 may use a random number generator to select a model type and may then use the random number generator to select a value for each hyper-parameter of the point. If the value selected for the hyper parameter is forbidden, random point generator 60 may try again until it produces a valid value. Similarly, if the chosen hyper-parameter is not valid because of a dependency on another hyper-parameter H, then random point generator 60 may go back to the other hyper-parameter H and may select a new value for it.

Point spawner 52 may utilize an optimizer 62, such as one which implements Bayesian optimization. An exemplary discussion of Bayesian optimization may be found in the article by Snoek, Jasper, Hugo Larochelle, and Ryan P. Adams and entitled “Practical Bayesian Optimization of Machine Learning Algorithms.” Advances in Neural Information Processing Systems. 2012, which article is incorporated herein by reference. Briefly, the Bayesian optimization process may generate an estimation of the expected score function S over the hyper parameters space. It may also estimate the standard deviation Q of the estimation. It may then select a vector in hyper-parameter space 22 that may maximize S+k*Q, where k is a constant. Point spawner 52 may, in addition, check the selected points to avoid new points that are too close to points already selected in order to have a diversity of “errors” so that when the best models are combined into an ensemble, one model will compensate for the errors of another.

Point spawner 52 may also utilize a “meta learning” unit 64 (i.e. learning from results of similar, previously performed, modeling operations) as described in the article by Ali, Shawkat, and Kate A. Smith and entitled “On Learning Algorithm Selection for Classification.” Applied Soft Computing 6.2 (2006): 119-138, which article is incorporated herein by reference.

In another embodiment, point spawner 52 may optimize the search for hyper-parameters to generate significant diversity in the models, which is crucial for the generation of a good blend of models. When using optimizer 62, point spawner 52 may look for new models which are significantly far from the current model and may tolerate a reduction in scores for the new models, at least for a short period of time.

In one embodiment and when using optimizer 62 and meta learning unit 64, point spawner 52 may measure the distance between points in hyper-parameter space. Point spawner 52 may allow the distance to be relatively close for a few iterations but, after that, may require that new points be further away. The distance may be defined according to any vector distance metric.

In another embodiment, point spawner 52 may optimize its search by defining the score of a model according to its contribution to the latest blend or ensemble. Thus, if a model received a score S and is R % of the latest blend, then point spawner 52 may register the model's score as S+KR, where K is a predefined constant, and may optimize its search with this new score. In this embodiment, point spawner 52 may optimize the blend, rather than the models.

In a further embodiment, point spawner 52 may utilize a combination of random point generator 60, optimizer 62 and meta learning unit 64. For the first K1 point selections from the start of the model search, where K1 may be a predefined value, point spawner 52 may utilize random point generator 60 and meta learning unit 64, each with a 50% probability. In a second phase, generally lasting K2 point selections, point spawner 52 may linearly increase the probability of activating optimizer 62 and accordingly, may reduce the probabilities of utilizing random point generator 60 and meta learning unit 64, such that after the K2 point selections, point spawner 52 may have 33% probabilities for each of random point generator 60, optimizer 62 and meta learning unit 64.

If, after achieving equal probabilities for each of random point generator 60, optimizer 62 and meta learning unit 64, the most recent model found by modeling services 18 has score that is better, by a factor F, than the best score known so far, then point spawner 52 may increase the probability of selecting points from optimizer 62 to 60% while reducing the probability of selecting points from random point generator 60 and meta learning unit 64 to 20% each. After K3 point selections, point spawner 52 may change the probabilities back linearly to 33% each. Point spawner 52 may generate a list of new points (i.e. sets of hyper-parameters) and may share the list with modeling services 18. Each point selector 56 in modeling services 18 may select which set of hyper-parameters from the list to run and may mark the list with their selection. Point spawner 52 may send information about each new spawned set of hyper-parameters to progress tracker 42.

Each point selector 56, in independent modeling services 18, may select a point defining a set of hyper-parameters, from the list based on their service's computational abilities and the resources required for the calculation indicated by the hyper-parameters. Typically, for each point in the list, each point selector 56 may estimate the computation resources required to build a model and pre-process this point, based on the modeling service's 18 attributes, such as amount of RAM, CPU type, number of processing cores, type of GPU (graphics processing unit), installed software libraries, available memory, installed operating system, etc. For example, a modeling service 18 with a GPU may prefer to run neural algorithms types of models while a modeling service 18 with a lot of memory may prefer decision-tree based algorithms that may require a lot of RAM memory, etc. In addition, point selector 56 may select a point based on an order of points in the list and which ones have already been chosen by the other modeling services 18.

In addition, only modeling services 18 that are currently available will select to run one of the available models. It will be appreciated that this is a distributed operation; no central controller indicates which point each modeling services 18 is to take, nor is there a predefined amount of computing resources dedicated to the entire modeling task at the beginning of the task The distributed operation may ensure that there is no single point of failure, to generally avoid a bottleneck when the number of services required becomes very large and to be able to adapt the task to the resources available in every node.

Each preprocessing model generator and scorer 58 may then set up and run the modeling task, on the first portion, the training portion, of the data, using the selected preprocessing hyper-parameters for a preprocessing operation and the selected modeling hyper-parameters for the modeling operation. Each preprocessing model generator and scorer 58 may iterate to determine the relevant algorithm parameters which provide the best match to the data. Preprocessing model generator and scorer 58 may generate a score for its run on the first portion of the data and may provide its results to its results analyzer 57.

If the model computation time or resources exceed the amount of time allocated to all model computations within this task, preprocessing model generator and scorer 58 may stop its work on this task, may give a low score to indicate failure and may report this directly to success determiner 54. Otherwise, preprocessing model generator and scorer 58 may provide the generated model to results analyzer 57 who may, in turn, verify the score, using the selected score metric, on the second portion, the validation portion, of the data. Results analyzer 57 may then provide the validated score, along with the hyper-parameter point, to success determiner 54 and to progress tracker 42.

It will be appreciated that modeling services 18 may provide low scores any time a model performs poorly by some measure. For example, a user may define one or more “poor performance” measures, such as a maximum level of complexity of the model (i.e. the number of parameters defining the model), the maximum amount of memory used to implement the model or a maximum number of algorithm parameters for the model. Scorer 18 may provide a low score to any model which reaches any of these maximum levels.

It will be appreciated that the poor performance measures may enable a user to ensure that the resultant model, while maybe not optimal, may provide a sufficiently accurate model while remaining non-complex or explainable or may provide a reasonably quick prediction.

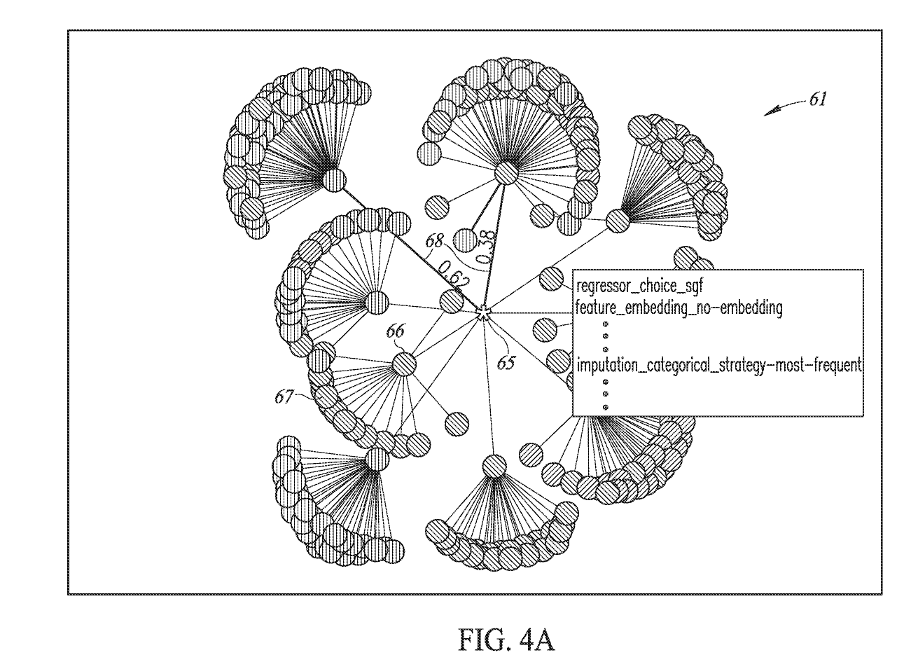

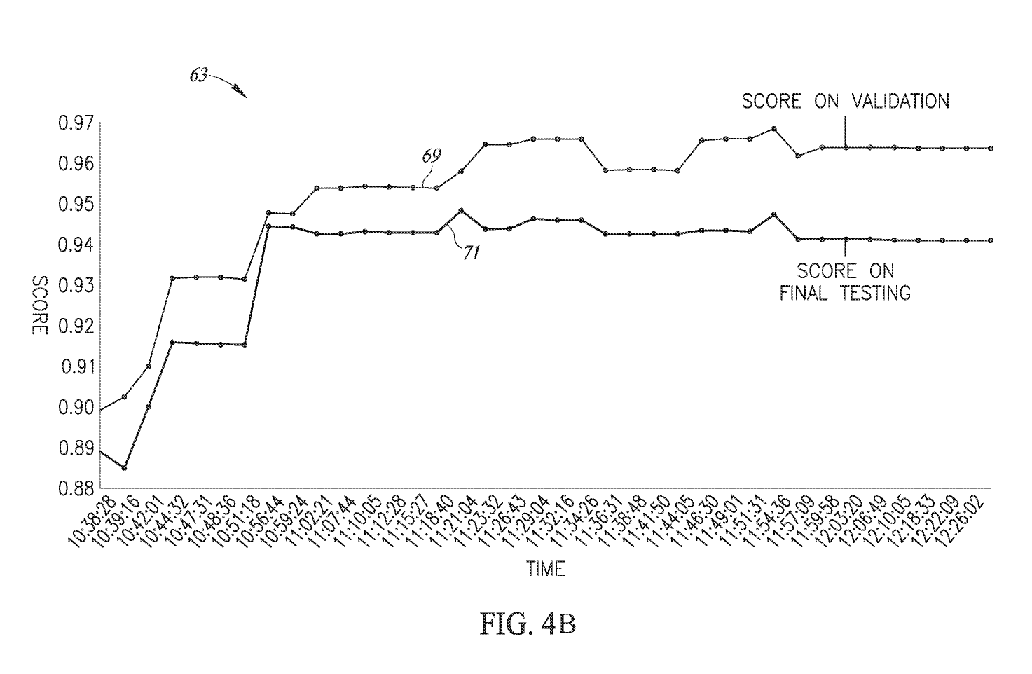

Reference is now made to FIG. 4A, which illustrates a progress graph 61 generated by progress tracker 42, and to FIG. 4B, which illustrates a score graph 63. Progress graph 61 may comprise a starting dot 65, from which extend a few main branches ending with a main node 66, each of which relates to a general type of model. From main nodes 66 extend model branches ending with a model point 67, each of which refers to one model, or hyper-parameter point, spawned from a main node 66.

Thus, each point on graph 61 refers to a point in hyper-parameter space. Indeed, when a user clicks on any of nodes 66 or 67, progress tracker 42 may list the hyper-parameters associated with that node. FIG. 4A shows one such list of parameters. The user may utilize this for monitoring and intervention if required. For example, the user may instruct the system to stop the search for a particular algorithm type based on the information he sees in the graph.

Graph 61 also comprises a few thick branches 68. These indicate a member of the current blend of models and the value listed above it indicates the member's portion of the blend. For example, if the value is 0.38, then that model forms 38% of the current blend.

Progress tracker 42 may continually update graph 61, as models are added or removed, are currently being calculated and have finished their calculations. The graph may utilize different colors to indicate the different states of the different models.

Score graph 63 may indicate the changing progress of the scores over time and may graph the scores 69 generated by results analyzer 55 on the validation (or second portion) of the data and the scores 71 generated by blender generator 57 on the final testing (or third portion) of the data. As can be seen, both sets of scores 69 and 71 converge towards a final level, though the final level of the blended scores 71, in this example, are lower than those of the validation scores 69.

It will be appreciated that, with modeling services 18, system 10 may make use of the kind of “micro services” available from cloud-based computing services. This may provide efficient parallelism and may enable system 10 to scale with the size of the task. Moreover, by enabling modeling services 18 to decide which points to select based on their current tasks and computing resources, system 10 may efficiently utilize large scale resources with distributed processing.

It will be appreciated that each modeling service 18 may be implemented as a single computing device or it may use distributed computing. In the latter embodiment, some or all of the modeling services 18 may utilize a cluster of computers, typically using software packages like Apache Spark™ (all the information available at https://spark.apache.org/) and Apache Spark Mlib (available at https://spark.apache.org/mllib/), both of which are incorporated herein by reference.

Further, system 10 does not generate an apriori list of hyper-parameters for all the models it expects to need in order to finish the task. Instead, spawning multiple models with different operational and preprocessing parameters may provide system 10 with a significant amount of flexibility and fault tolerance (i.e. if one modeling service 18 fails, others may take up its tasks). System 10 may have further flexibility since each modeling service 18 may select its next modeling tasks to perform based on its current status and on its unique hardware and software characteristics.

Moreover, the method of spawning may change, depending on the type of modeling task. It may be based on previous modeling results, random generation, optimization of the results or optimization of the blend of models.

Finally, system 10 may provide a graphical representation of the process, which may enable users to follow the modeling process as new processes are spawned and old ones are removed and may enable users to see the modeling process converge to a solution.

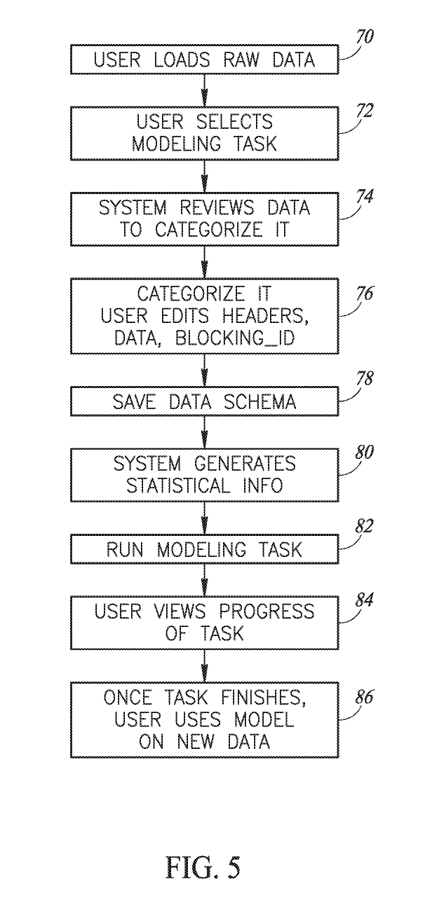

Reference is now made to FIG. 5, which illustrates a workflow for system 10.

Initially (step 70), a user may load the raw input data. The data may be in a single table or it may be a loaded using an adapter to another system or other databases. Then (step 72), the user may select the problem to be solved, by selecting a modeling task. As described hereinabove, the modeling task may be one of regression, classification, recommendation, anomaly detection, etc.

Data preparer 12 may present (step 74) the data to the user in columns. Data preparer 12 may also determine the type of each column (e.g. numerical, time, categorical) and may present a warning if it can't determine the type. The user may edit (step 76) the data, such as define if there is title row or not, edit the column types, define target scores (for all types of modeling except recommendation). In anomaly detection, the target score may be a weighted sum of the number of misclassified anomalies and non-anomalies. In classification, the target score may be the number of misclassified samples, while in regression and time series, the target score may be the average absolute difference between a desired y value and the regression result.

In addition, the user may provide a “Blocking_ID”, a data value to indicate a division of samples with similar Blocking_ID values between validation and training datasets such that these samples exist only in training or validation datasets. Blocking_ID values are used in classification, anomaly detection, regression and timeseries regression.

With this, the data is ready to be used. Thus, in step 78, the user may define and save a data schema, defined by the types assigned to each feature, whether there are titles, etc.

Data preparer 12 may generate standard statistical calculations, such as histograms, scattergrams, minimum and maximum values, standard deviation, count, number of undefined values (known as NaN), etc. Data preparer 12 may also determine (step 80) importance measures. The importance measure may be calculated using mutual information between each column/feature and a target or with SKlearn importance Feature importances may be determined with forests of trees, as described in http://scikit-learn.org/stable/auto_{—}examples/ensemble/plot_forest_importances.html, incorporated herein by reference.

In step 82, the user may activate modeling ensemble generator 14 to run a modeling task on the schema defined above. Moreover, the user may define parameters for the run, such as: test method (cross validation or hold out), number of cross validation “folds” (a parameter for the cross validation process), maximum number of models to run, maximum number of models to use for the blend, score threshold to use for blend, algorithm types to use for the search, score used for optimization, whether the scores are to be displayed, a maximal run time for each algorithm and an overall maximal run time.

During the model generation process, the user may view (step 84) the progress of the score of the blends, calculated after every N models are generated. The user can also see the progress via progress graph 60 and may set its parameters.

Once the model is calculated, data coordinator 30 may store the final blend in central storage unit 38 and predictor 16 may utilize it to generate predictions given a new dataset from the user. The predictions may be implemented by sending a single sample set to predictor 16 and waiting for the result. The user may alternatively send a batch of samples to predictor 16 and may wait for the results of the batch prediction. Further alternatively, sometimes predictor 16 may operate in real-time when the response needs to be very fast.

Furthermore, in order to accelerate prediction and/or to reduce storage size, the user may specify a maximal complexity of each of the models in the ensemble. With this parameter, system 10 will not use models that are more complex for building the ensemble. The complexity of the models may be represented by their size in memory or by their number of internal parameters.

Further alternatively, exporter 44 may export the models. Exporter 44 may export a code of a library or a container (such as Docker container as explained in https://docs/docker.com/, incorporated herein by reference) that may be integrated into the user system so that the prediction may be done autonomously.

The Optimization Process

As discussed hereinabove, point spawner 52 may optimize hyper-parameters of preprocessing and of the model algorithms. In each iteration, point spawner 52 may generate new hyper-parameters in one of three ways. Point spawner 52 may take a new point in hyper-parameter space 22 at random. Point spawner 52 may utilize Bayesian optimization methods or using other optimization algorithms.

Moreover, point spawner 52 may take a new point derived from meta learning. Meta learning finds previous data files which are similar in some way, for example by having similar data features to the current input data, as explained in the paper by Ali, et al. mentioned hereinabove. Using meta learning, point spawner 52 may utilize points in hyper-parameter space for which those similar data sources received good scores. For example, if small datasets which have high variability in the Y values, low amplitudes in all X values and are missing 2% of their data get a high score when using neural networks with certain hyper-parameters, then the meta learning will suggest such a point in hyper-parameter space for the current dataset which has the same characteristics.

In generating new points, point spawner 52 may also consider a) the score of previous models and their hyper parameters, the resources (memory, computation power) needed for the computation of the model parameters and the characteristics of the data (number of samples, number of features as indicated by the number of columns in the input file, statistics of each feature, measures taken on the rows of the input file, such as their average, measures of the relationships between sample vectors, such as the average distance between samples that belong to a same class). Point spawner 52 may comprise a meta learning service, formed of a regressor, that may attempt to predict a score as a function of the features of the incoming data. Point spawner 52 may use the meta learning service to search for points in the hyper parameters space that may yield a high score.

Point spawner 52 may provide the meta learned point, as well as points generated in other ways, to modeling services 18, each of which may be implemented in a computation node, which may be a core in a multi-core CPU, another computer or a cloud instance. Each modeling service 18 may build a model based on its selected point in hyper-parameter space and may calculate the corresponding score. The model and score are returned to success determiner 54 which may either use the score, if good enough, for ensemble creation and/or may provide it to point spawner 52 to determine the next points in hyper-parameter space 22.

The user may view the progress of model runner 32 and may see the scores of the blended models. He may pause or stop model runner 32 at any time and may use the latest generated blend.

Testing Process

Each results analyzer 55 may test the generated model to check its score. However, the models may not be tested on the data that produced them (or that they were trained on) since this will not be accurate and may be prone to over-fitting. As discussed above, this test is done on the second portion of the data, i.e. the validation data.

As mentioned hereinabove, system 10 may utilize either hold out or cross-validation data. It is noted that, for cross validation (CV), a set of several models with similar hyper-parameters are generated and each is given a slightly different dataset to work on, where each dataset has a different portion of the data saved for validation and testing. The scores of the set of models are averaged to generate a score estimation for an average point representing the set of models. This CV approach is useful when there is limited amount of data.

Time Series

Time series prediction requires each data sample to have a time stamp. For these, model generator and scorers 58 may generate a model that predicts the next value in a given series of samples. For example, the model might predict the number of products sold as a function of sales in previous weeks, whether the next days are holiday or regular days and the exchange rate of the dollar vs. Euro. Modeling ensemble generator 14 may support time series predictions given M (external) values (a “multi-variate” time series prediction) or predictions based solely on the previous Y values (a “uni-variate” time series prediction).

Time series predictions are different from regular regression modeling since the user needs to specify the time frame to be predicted and needs to provide a “history” of samples. If the model was built using information with a timestamp later then the timestamp of the data used for testing, there may be “data leakage”, meaning that the later data used for building the model may have hidden information about the earlier data used for testing. Therefore, the testing requires a check on the time frame of the data to be tested versus the data used for the modeling.

It will be appreciated that modeling services 18 may be implemented with cloud services or on-premises. For the latter, modeling services 18 may be implemented in any suitable computation node, which may be a core in a multi-core CPU, another computer or a cloud instance. Each processing node for each modeling service 18 may be different in terms of memory, number of computation cores, memory access speed, storage size, etc. Point selector 56 may select its points to model based on these features.

The hardware may include servers and/or hardware accelerators such as GPUs. The operating system may be Linux, Windows, Android or any other.

It will be appreciated that system 10 may generate a set of models that are good candidates for generation of the best ensemble or blend. In many cases (for example, multi-class classification problems), an ensemble of models with low scores may be better than a model with higher scores.

The user may exclude certain algorithms and/or pre/post processing steps or may favor certain algorithms by increasing the probability that they will be selected.

In an alternative embodiment, the user may generate plug-in functions in order to define new model score functions or in order to define new machine learning algorithms that will be used by system 10. To do so, the user will code the score function in a programming language (for example, R of python) such that the coding will comply with a specific API (application programming interface). From UI 40, the user will select the source code file containing the function, will indicate to system 10 whether it is a new algorithm or a new score function and will assign a name for it. System 10 will then link the code of the new function into each model generator and scorer 58 and will update UI 40 so that the user may select to use this algorithm or this new score function.”

Unless specifically stated otherwise, as apparent from the preceding discussions, it is appreciated that, throughout the specification, discussions utilizing terms such as “processing,” “computing,” “calculating,” “determining,” or the like, refer to the action and/or processes of a general purpose computer of any type such as a client/server system, mobile computing devices, smart appliances or similar electronic computing device that manipulates and/or transforms data represented as physical, such as electronic, quantities within the computing system's registers and/or memories into other data similarly represented as physical quantities within the computing system's memories, registers or other such information storage, transmission or display devices.

Embodiments of the present invention may include apparatus for performing the operations herein. This apparatus may be specially constructed for the desired purposes, or it may comprise a general-purpose computer selectively activated or reconfigured by a computer program stored in the computer. The resultant apparatus when instructed by software may turn the general-purpose computer into inventive elements as discussed herein. The instructions may define the inventive device in operation with the computer platform for which it is desired. Such a computer program may be stored in a computer readable storage medium, such as, but not limited to, any type of disk, including optical disks, magnetic-optical disks, read-only memories (ROMs), volatile and non-volatile memories, random access memories (RAMs), electrically programmable read-only memories (EPROMs), electrically erasable and programmable read only memories (EEPROMs), magnetic or optical cards, Flash memory, disk-on-key or any other type of media suitable for storing electronic instructions and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A data modeling platform comprising:
a modeling ensemble generator to preprocess and model an input dataset according to a user listing of modeling types, modeling algorithms and preprocessing operations for modeling ensemble generator to use; and
a progress tracker to display a progress of said modeling ensemble generator, wherein said modeling ensemble generator comprises:
a plurality of model runners, one per modeling type, each operating with a changing plurality of independent modeling services, each model runner generating a changing set of points in a hyper-parameter space defining hyper-parameters for said listed modeling algorithms and preprocessing operations, and each said modeling service modeling said data using a selected one of said hyper-parameter points and generating a validated score for said selected hyper-parameter point; and
a data coordinator to coordinate the operation of said model runners and to provide said hyper-parameter points and their resulting scores generated by said independent modeling services to said progress tracker.

2. The data modeling platform according to claim 1 and wherein each said model runner comprises:
a point spawner to generate said hyperparameter points across said hyper-parameter space and to provide said points to said progress tracker;
a success determiner to receive said scores from said modeling services and to select those of said validated scores indicating a quality match to said data; and
a blender generator to blend together a group of said selected scores to generate a blended model providing better results than each said validated score by itself and to validate said blended model on a portion of said input data not utilized by said modeling services.

3. The data modeling platform according to claim 2 and wherein said point spawner comprises at least one of:
a random number generator to select points at random;
an optimizer to select points in order to find scores providing better results than previously generated by said modeling services; and
a meta learning unit to select points based on score results produced with a similar dataset to said input dataset.

4. The data modeling platform according to claim 2 and wherein said optimizer comprises a searcher to search for new hyper-parameter points by adjusting the score of a point according to its contribution to a current blended model.

5. The data modeling platform according to claim 2 and wherein said progress tracker comprises:
a grapher to graph said points in a branched node graph representing the progress of said model runners, where branches in said graph represent one of: time, hyper-parameters or algorithm type; and
a user interface to provide said hyper-parameters and said score associated with a user-selected node.

6. The data modeling platform according to claim 1 and wherein said modeling types comprises classification, recommendation, anomaly detection, regression, and time-series prediction.

7. The data modeling platform according to claim 1 and wherein each said modeling service comprises:
a computing device having computational abilities and resources;
a point selector to select a hyper-parameter point to model based on said computational abilities and resources compared to those required for a model indicated by said selected hyper-parameter point;
a pre-processing model generator and scorer to run said model indicated by said hyper-parameter point on a first portion of said input data to determine algorithm parameters of said model and to generate an initial score for said selected hyper-parameter point; and
a results analyzer to generate said validated score by running said model on a second portion of said input data.

8. The data modeling platform according to claim 7 and wherein said computational abilities and resources comprise at least one of: amount of RAM, CPU type, number of processing cores, type of GPU (graphics processing unit), installed software libraries, available memory, and installed operating system.

9. The data modeling platform according to claim 7 and wherein said computing device is part of a cloud-based computing service.

10. The data modeling platform according to claim 2 and also comprising a database to store at least final blended models generated by said modeling ensemble generator and an exporter to export said final blended models.

11. The data modeling platform according to claim 7 and wherein each said modeling service comprises a poor performance definer to define at least one of: a maximum level of complexity of the model, a maximum amount of memory used to implement the model, a maximum number of algorithm parameters for the model.

12. A data modeling platform comprising:
a distributed modeling ensemble generator to preprocess and model an input dataset according to a user listing of modeling types, modeling algorithms and preprocessing operations for modeling ensemble generator to use; and
a progress tracker to display a progress of said distributed modeling ensemble generator,
wherein said distributed modeling ensemble generator comprises:
a plurality of model runners, one per modeling type, each operating with a changing plurality of distributed independent modeling services, each model runner generating a changing set of points in a hyper-parameter space defining hyper-parameters for said listed modeling algorithms and preprocessing operations, and each said distributed modeling service modeling said data using a selected one of said hyper-parameter points and generating a validated score for said selected hyper-parameter point, said plurality of modeling services changing as a function of a convergence of a final model to said input dataset; and
a data coordinator to coordinate the operation of said model runners and to provide said hyper-parameter points and their resulting scores generated by said independent distributed modeling services to said progress tracker.

13. The data modeling platform according to claim 12 and wherein each said model runner comprises:
a point spawner to generate said hyperparameter points across said hyper-parameter space and to provide said points to said progress tracker;
a success determiner to receive said scores from said modeling services and to select those of said validated scores indicating a quality match to said data; and
a blender generator to blend together a group of said selected scores to generate a blended model providing better results than each said validated score by itself and to validate said blended model on a portion of said input data not utilized by said modeling services.

14. The data modeling platform according to claim 13 and wherein said point spawner comprises at least one of:
a random number generator to select points at random;
an optimizer to select points in order to find scores providing better results than previously generated by said modeling services; and
a meta learning unit to select points based on score results produced with a similar dataset to said input dataset.

15. The data modeling platform according to claim 13 and wherein said optimizer comprises a searcher to search for new hyper-parameter points by adjusting the score of a point according to its contribution to a current blended model.

16. The data modeling platform according to claim 13 and wherein said progress tracker comprises:
a grapher to graph said points in a branched node graph representing the progress of said model runners, where branches in said graph represent one of: time, hyper-parameters or algorithm type; and
a user interface to provide said hyper-parameters and said score associated with a user-selected node.

17. The data modeling platform according to claim 12 and wherein said modeling types comprises classification, recommendation, anomaly detection, regression, and time-series prediction.

18. The data modeling platform according to claim 12 and wherein each said modeling service comprises:
a computing device having computational abilities and resources;
a point selector to select a hyper-parameter point to model based on said computational abilities and resources compared to those required for a model indicated by said selected hyper-parameter point;
a pre-processing model generator and scorer to run said model indicated by said hyper-parameter point on a first portion of said input data to determine algorithm parameters of said model and to generate an initial score for said selected hyper-parameter point; and
a results analyzer to generate said validated score by running said model on a second portion of said input data.

19. The data modeling platform according to claim 18 and wherein said computational abilities and resources comprise at least one of: amount of RAM, CPU type, number of processing cores, type of GPU (graphics processing unit), installed software libraries, available memory, and installed operating system.

20. The data modeling platform according to claim 18 and wherein said computing device is part of a cloud-based computing service.

21. The data modeling platform according to claim 13 and also comprising a database to store at least final blended models generated by said modeling ensemble generator and an exporter to export said final blended models.

22. The data modeling platform according to claim 18 and wherein each said modeling service comprises a poor performance definer to define at least one of: a maximum level of complexity of the model, a maximum amount of memory used to implement the model, a maximum number of algorithm parameters for the model.

23. A method for a data modeling platform, the method comprising:
preprocessing and modeling an input dataset according to a user listing of modeling types, modeling algorithms and preprocessing operations; and
displaying a progress of said preprocessing and modeling,
wherein said preprocessing and modeling comprises:
per modeling type, running a plurality of models on a changing plurality of independent modeling services, each said running comprising generating a changing set of points in a hyper-parameter space defining hyper-parameters for said listed modeling algorithms and preprocessing operations, and each said modeling service modeling said data using a selected one of said hyper-parameter points and generating a validated score for said selected hyper-parameter point; and
coordinating said running to provide said hyper-parameter points and their resulting scores generated by said independent modeling services for said displaying.

24. The method according to claim 23 and wherein each said running comprises:
generating said hyperparameter points across said hyper-parameter space;
providing said points for said displaying;
selecting those of said validated scores indicating a quality match to said data;
blending together a group of said selected scores to generate a blended model providing better results than each said validated score by itself; and
validating said blended model on a portion of said input data not utilized by said modeling services.

25. The method according to claim 24 and wherein said generating comprises at least one of:
selecting points at random;
selecting points in order to find scores providing better results than previously generated by said modeling services; and
selecting points based on score results produced with a similar dataset to said input dataset.

26. The method according to claim 24 and wherein said second selecting comprises searching for new hyper-parameter points by adjusting the score of a point according to its contribution to a current blended model.

27. The method according to claim 24 and wherein said displaying comprises:
graphing said points in a branched node graph representing the progress of said preprocessing and modeling, where branches in said graph represent one of: time, hyper-parameters or algorithm type; and
providing said hyper-parameters and said score associated with a user-selected node.

28. The method according to claim 23 and wherein said modeling types comprises classification, recommendation, anomaly detection, regression, and time-series prediction.

29. The method according to claim 23 and wherein each said modeling service comprises:
selecting a hyper-parameter point to model based on said computational abilities and resources of a computing device running said modeling service compared to those required for a model indicated by said selected hyper-parameter point;
running said model indicated by said hyper-parameter point on a first portion of said input data to determine algorithm parameters of said model;
generating an initial score for said selected hyper-parameter point; and
generating said validated score by running said model on a second portion of said input data.

30. The method according to claim 24 and also comprising storing at least final blended models generated by said modeling ensemble generator and exporting said final blended models.

31. The method according to claim 29 and wherein each said modeling service comprises measuring performance as a function of at least one of: a maximum level of complexity of the model, a maximum amount of memory used to implement the model, a maximum number of algorithm parameters for the model.

32. A method for a data modeling platform comprising:
distributed preprocessing and modeling of an input dataset according to a user listing of modeling types, modeling algorithms and preprocessing operations; and
displaying a progress of said distributed preprocessing and modeling,
wherein said distributed preprocessing and modeling comprises:
per modeling type, running a plurality of models on a changing plurality of distributed independent modeling services, each running comprising generating a changing set of points in a hyper-parameter space defining hyper-parameters for said listed modeling algorithms and preprocessing operations, and each said distributed modeling service modeling said data using a selected one of said hyper-parameter points and generating a validated score for said selected hyper-parameter point, said plurality of modeling services changing as a function of a convergence of a final model to said input dataset; and
coordinating said running to provide said hyper-parameter points and their resulting scores generated by said independent distributed modeling services for said displaying.

33. The method according to claim 32 and wherein each said running comprises:
generating said hyperparameter points across said hyper-parameter space;
providing said points for said displaying;
selecting those of said validated scores indicating a quality match to said data;
blending together a group of said selected scores to generate a blended model providing better results than each said validated score by itself; and
validating said blended model on a portion of said input data not utilized by said modeling services.

34. The method according to claim 33 and wherein said generating comprises at least one of:
selecting points at random;
selecting points in order to find scores providing better results than previously generated by said modeling services; and
selecting points based on score results produced with a similar dataset to said input dataset.

35. The method according to claim 33 and wherein said second selecting comprises searching for new hyper-parameter points by adjusting the score of a point according to its contribution to a current blended model.

36. The method according to claim 33 and wherein said displaying comprises:
graphing said points in a branched node graph representing the progress of said preprocessing and modeling, where branches in said graph represent one of: time, hyper-parameters or algorithm type; and
providing said hyper-parameters and said score associated with a user-selected node.

37. The method according to claim 32 and wherein said modeling types comprises classification, recommendation, anomaly detection, regression, and time-series prediction.

38. The method according to claim 32 and wherein each said modeling service comprises:
selecting a hyper-parameter point to model based on said computational abilities and resources of a computing device running said modeling service compared to those required for a model indicated by said selected hyper-parameter point;
running said model indicated by said hyper-parameter point on a first portion of said input data to determine algorithm parameters of said model;
generating an initial score for said selected hyper-parameter point; and
generating said validated score by running said model on a second portion of said input data.

39. The method according to claim 33 and also comprising storing at least final blended models generated by said modeling ensemble generator and exporting said final blended models.

40. The method according to claim 38 and wherein each said modeling service comprises measuring performance as a function of at least one of: a maximum level of complexity of the model, a maximum amount of memory used to implement the model, a maximum number of algorithm parameters for the model.
